(19) United States
(12) Patent Application Publication
(10) Pub. No.: US 2020/0351287 A1
(43) Pub. Date: Nov. 5, 2020

(54) ADDRESS RESOLUTION REQUEST CONTROL

(71) Applicant: HEWLETT-PACKARD DEVELOPMENT COMPANY, L.P., Spring, TX (US)

(72) Inventors: Stuart Lees, Bristol (GB); Adrian Baldwin, Bristol (GB); Daniel Ellam, Bristol (GB); Jonathan Griffin, Bristol (GB)

(21) Appl. No.: 16/606,847

(22) PCT Filed: Jan. 26, 2018
(86) PCT No.: PCT/US2018/015532

§ 371 Date: Oct. 21, 2019

(51) Int. Cl. H04L 29/06; H04L 29/12

(52) U.S. Cl. CPC H04L 63/1425; H04L 63/1416; H04L 63/145; H04L 61/10

(57) ABSTRACT

A method for address resolution request control in a network device of a network, the method comprises comparing address resolution requests submitted to network nodes from the network device against a predetermined threshold profile for the network device, and regulating a flow of address resolution requests from the network device in response to the comparison.

### BACKGROUND

Self-propagating malware that infects a machine can search for other hosts to infect, with hosts on the same local area network (LAN) subnet presenting the easiest targets as they offer the least chance of being detected by network intrusion detection devices.

Since malware uses the infected machine's network stack, it uses the same address resolution protocols, such as the address resolution protocol (ARP), which is used for device address resolution in IPv4, and neighbour solicitation, which is used for device address resolution in IPv4.

### BRIEF DESCRIPTION OF THE DRAWINGS

Various features of certain examples will be apparent from the detailed description which follows, taken in conjunction with the accompanying drawings, which together illustrate, by way of example only, a number of features, wherein:

FIG. 1 is a flowchart of a method according to an example;

FIG. 2 is flowchart of a method according to an example;

FIG. 3 is a flowchart of a method to initiate regulation of address resolution requests according to an example;

FIG. 4 is a flowchart of a throttling state according to an example;

FIG. 5 is a flowchart of a non-throttled state according to an example;

FIG. 6 is a flowchart of an ArpW process flow according to an example;

FIG. 7 is a flowchart of a process to exit throttling according to an example; and

FIG. 8 shows an example of a network device comprising a processor associated with a memory according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Once infected with, for example, self-propagating malware, a machine can very rapidly scan IP addresses for other potential malware hosts (nodes) on the same subnet as the infected machine. Searching for an appropriate attack target within the same LAN subnet in this way can be observed as a rapid set of address resolution requests, which is atypical behaviour since a machine will generally have a relatively small set of devices that it usually communicates with, such as printers, network routers and so on.

Depending on the Internet protocol (IP) in use on an infected machine (IPv4 or IPv6), there are two ways in which malware can try to resolve the addresses of other potential target nodes on the network. The address resolution protocol (ARP) is a protocol used to map IP network addresses (such as 10.11.13.15 for example) to hardware addresses used by a data link protocol (such as 34:8f:99:c9:ff:59 for example)—for example when IPv4 is used over Ethernet.

For data to be sent from one device to another the sending device has to know the hardware address of the receiver (be it another device or a router) and it does this by broadcasting a request to its local network. Since it is broadcast, it is received by all systems in the same collision domain (local area network, LAN). The target of the request responds, and the other systems discard the request. In this way, any system utilising IPv4 can discover the hardware address of the device it wishes to start communications with and can begin transmitting data.

Due to the lack of addressing space within IPv4 and the growth of internet enabled devices, IPv6 was formed with the intention of solving the addressing issue and improving other mechanisms. One such change was to not use broadcasts with IPv6. However, address resolution is still fundamental to communications between devices, and is accomplished in a different but very similar way, known as Neighbour Solicitation in IPv6. Reference herein to address resolution and address resolution request encompass both ARP in IPv4 and neighbour solicitation in IPv6 since there is no practical difference, in terms of implementation of the method and system described herein, between either case.

According to an example, there is provided a method for detection of and response to an abnormal number of address resolution requests or device connection attempts in order to mitigate the spread of malware. A system according to an example can monitor and react to address resolution and device discovery activity so that when suspected malware style activity is detected, the system can begin throttling untrusted discovery and connection activity with appropriate alerting, constructed through leveraging a system of dynamic automatically generated lists of trusted address connections from the monitoring and possible other sources.

As noted above, an average endpoint device has a limited set of other devices it communicates with daily. These tend to comprise of devices such as a router or a printer or a file server, and it is rare that connections are directly made to many other endpoints. Malware can use the device's known list of hardware addresses obtained from its cache to initiate attacks directly at those devices, but for other devices within the same LAN it must first learn of their addresses using the address resolution mechanisms within IPv4 or IPv6. For devices that are off-subnet, malware takes a more opportunistic approach and will attempt to connect with devices as a method for discovering if they are valid targets.

Self-propagating malware has a particular pattern of polling for neighbours on the LAN of a host in order to discover and attempt to infect any device that responds to it. The polling is generally rapid, so as to quickly spread amongst hosts before the victims can act to stop the spread. Thus, according to an example, outgoing address resolution requests (e.g. ARP requests in IPv4, and Neighbour Solicitation requests in IPv6) and the first connection attempt to a device are monitored and information about their targets and regularity are recorded. This information can then be compared against thresholds that represent malware behaviour and that differ from normal device behaviour. In response, a flow of address resolution requests from the network device can be regulated. That is, once a throttling threshold has been reached, address resolution and discovery can be moderated or throttled to limit device connections with appropriate alerting. For example, the number of unique address resolution requests per second from a network device can be monitored, and when a threshold is reached, requests to previously unvisited destination addresses can be stopped or blocked. This would have the effect of limiting the number of new hosts that could be reached whilst having minimal impact on typical legitimate usage.

According to an example, a set of identifiers representing network nodes forming actual or potential targets of an infected machine can be provided, such as in the form of a history list for example. This can be used as a source of known ‘good’ addresses (i.e. addresses of nodes that are known to be legitimate or common devices that are used or communicated with by the network device in question) and can be formed in a number of ways and, in an example, can be dynamic reflecting the mutability of IP-MAC/socket pairings. In an example, good addresses can be those IP and MAC address plus socket matches or the IP or MAC addresses depending on policy.

According to an example, an automatically learned list based on successful address requests made by the device can be generated. For example, the network device can maintain a list of devices that it usually communicates with, as noted above. This can include information such as the time the address was first requested with a successful response, the number of times it has successfully resolved since and the last time the address was resolved, traffic type and socket ports etc. In this way, common devices such as routers and so on can be identified and trusted. In an example, there can be an associated age parameter, so that entries for devices that have changed address or are not commonly used can be pruned to keep the list current.

A manually created list, judged to be a legitimate list of addresses the device may communicate with, can be provided. In an example, this can take the form of a subnet addressing format if there are certain IP addresses within the subnet deemed to always be allowed (for example 10.10.10.0/26 representing a set of file servers and/or printers etc) or lists of MAC addresses etc. An enrichment source, such as a provided URL containing a list of known good IP addresses to MAC address pairings, subnet lists, common traffic definitions or other alternatives which can be refreshed and kept up to date can be provided, and the last good history list prior to a reboot of the network device can be provided.

Any combination of the above can be used to form the set of identifiers. For example, a set can comprise an initial manual list, updated with an enrichment source that is further appended to by automated discovery.

In an example, there can be special addresses, for example router IP addresses can be learned from a DHCP request and so this address could be implicitly trusted and requests for this address always allowed despite the throttle status. Likewise, a DHCP server address, once discovered, could always be allowed so devices can maintain addressing whilst a throttle is engaged. Other protocol specific addresses could also be trusted in this manner per policy choices.

According to an example, whilst address resolution requests are being moderated or regulated (i.e. there is a system throttle in place), new unknown addresses are not added to a learned history list such as that described above. In an example, there can be logging of the information in the history list, or periodically updated blacklists of known bad addresses could be compared against the history list leading to additional alerts. There may be one history list maintained for the device, or lists maintained according to other criteria, such as per networking device, sub-interfaces or logged in users etc.

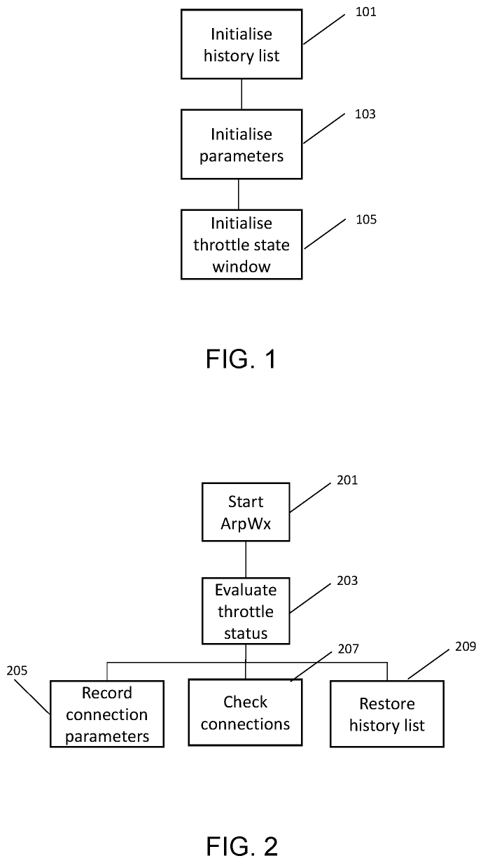

FIG. 1 is a flowchart of a method according to an example. More particularly, FIG. 1 is a flowchart of a method for initialisation according to an example. In block 101, a set of identifiers representing network nodes forming actual or potential targets of an infected machine is initialised in the form of a history list (either new or from stored list e.g. after a reboot of the network device). In block 103, device connection activity window, ArpW, parameters are initialised or restored. More specifically, in an example, an observation window is used in order to enable triggering of throttling behaviour. To this end, a summary of address resolution request behaviours over an interesting observation window or windows can be used. This activity window can take many forms, for example, it can be a static defined length, using time or other parameters, a rolling window over time or other parameters, a window that varies in length per parameters, for example time since last request or time since last non-response or an analysis of the running processes, or on statistics gathered over one or more windows. Observation window types can be switched based upon policy, for example whilst throttling or reacting to other devices behaviour (e.g. they are throttling) or CPU usage on the device etc.

In block 105 a throttle state (TS) and window (TSW) are initialised along with a throttle parameter, C. In an example, TS can maintain the current throttle status (throttled or not), TSW is a minimum window of time (or ArpW windows) for which throttling will be engaged once started and C is a counter of address resolution requests.

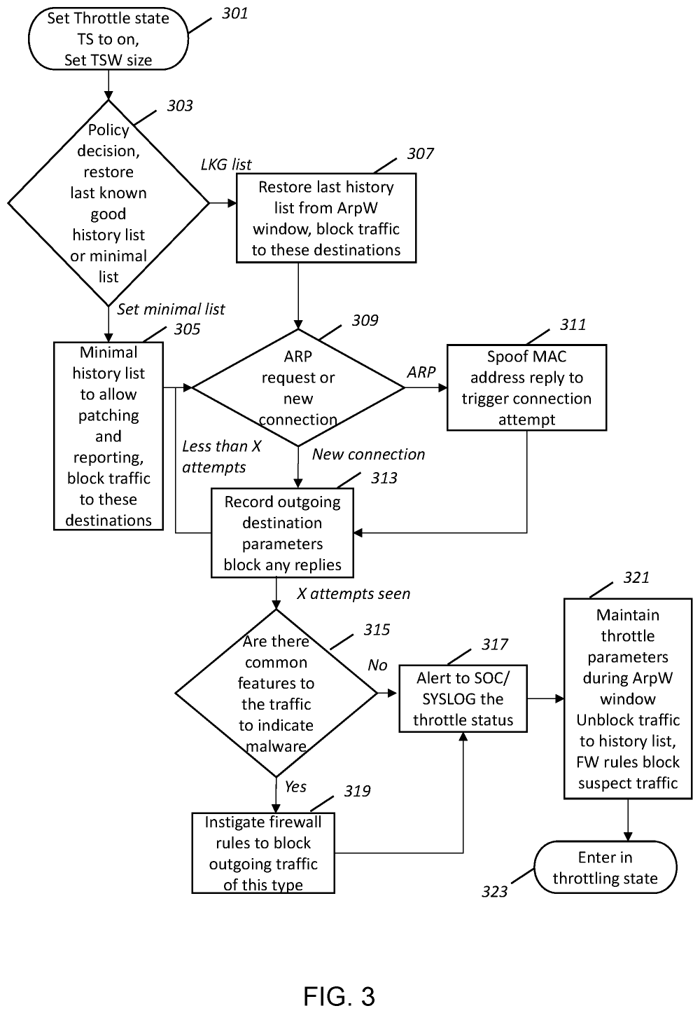

FIG. 2 is flowchart of a method according to an example. In block 201, ArpWx starts, where x indexes ArpW. That is, an observation window can be started in which address resolution requests from a network device are monitored. In block 203, a throttle status is evaluated (throttled or not). In block 205, in which the network device is in a non-throttled state, connection parameters are recorded and stored in history list (see FIG. 3). New entries learned during this ArpW can be appended to the history list backup, so that over time this list becomes a good representation of the other hosts the device regularly interacts with.

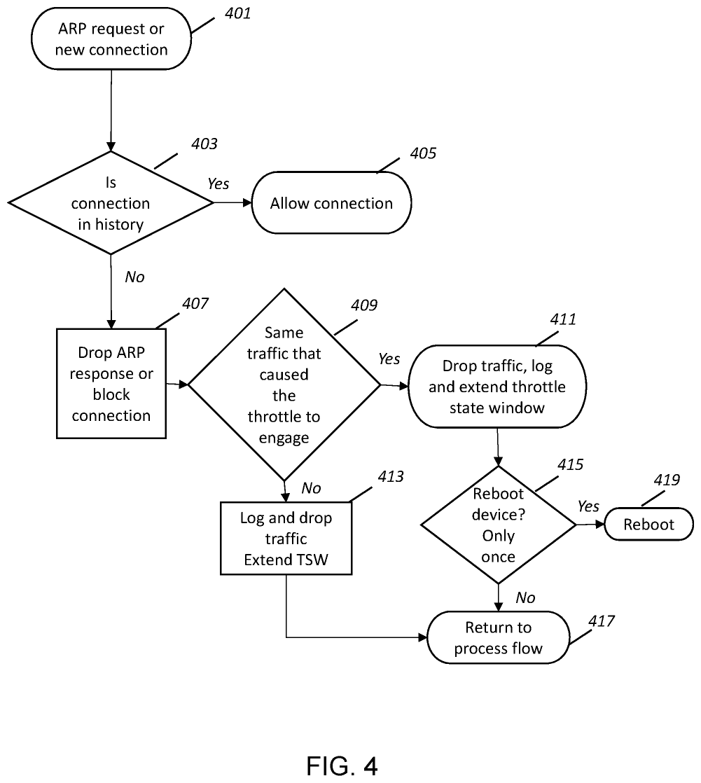

In block 207, in which the network device is in a throttled state, connections are checked against a history list and either blocked or allowed (see FIG. 4). This allows known good behaviour whilst the throttle is active. In block 209, ArpWx ends, and a throttle state change is evaluated in block 211. If there is no change the process returns (block 213) to block 201 where a new window is started. This allows the throttle to understand when address resolution traffic returns to accepted levels, or to act if the suspect traffic does not subside. A device reboot may be attempted, but only once to avoid boot loops if the malware is persistent.

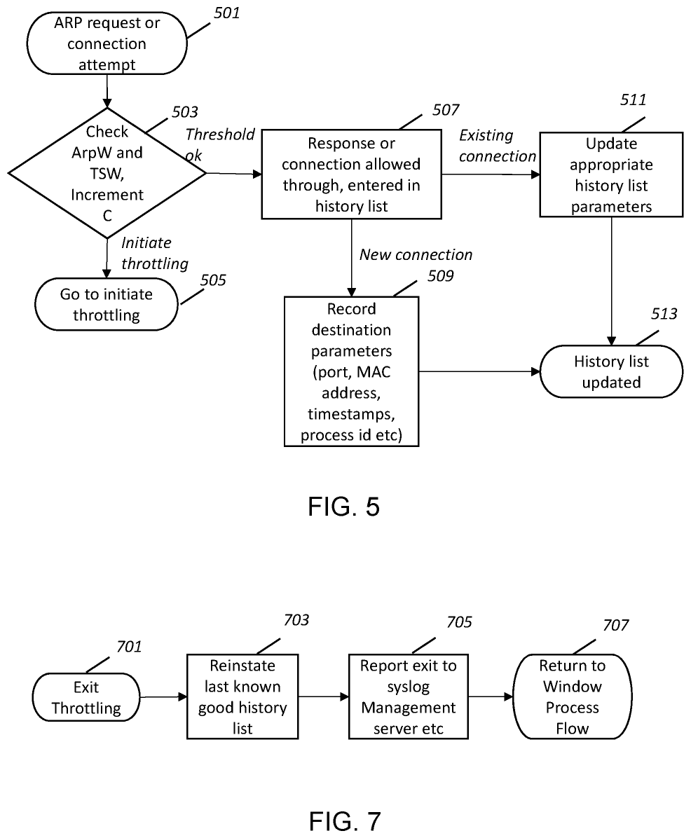

In the event that throttling is to be exited (stopped) in block 215, and exit process is initiated (FIG. 5). A current history list can be stored as a backup copy if throttle is not active. If a threshold is still exceeded, the throttle state window can be extended. If TSW has expired and suspect traffic has subsided, the throttle can be exited (see exit throttle flow of FIG. 5). In an example, the network device could be rebooted if traffic is still persistent after the TSW timer expiry.

FIG. 3 is a flowchart of a method to initiate regulation of address resolution requests according to an example. That is, FIG. 3 is a flowchart that shows a process used to initiate throttling according to an example. As described above, in block 301 a throttle state (TS) is set, and in the case of FIG. 3 it is set to on (i.e. requests are regulated or throttled). The TSW size is also set in block 301. In block 303, a decision based on a policy for the system in question is used to decide whether to restore the last known good history list (set of identifiers representing network nodes) or start with a minimal list. In block 305 (minimal list selected in block 303) a minimal list is set. In block 307 (last known good list selected in block 303) the last known good list is restored.

In block 309 an address resolution request or a new connection is made by the network device. When the last known good list is set, and an address resolution request is made in block 309, the MAC address can be spoofed in block 311 to the trigger a connection attempt, and the outgoing destination parameters can be recorded in block 313 and any replies blocked. When the last known good list is set, and a new connection attempt is made in block 309, the outgoing destination parameters can be recorded in block 313 and any replies blocked.

If a minimal list is set in block 305, and less than a predetermined threshold number of address resolution requests have been made, outgoing destination parameters can be recorded and any replies can be blocked in block 313. Otherwise, the process from block 109 described above is followed.

In block 315, at the point where a threshold number of attempts are detected, it is determined if there are any common features to the traffic to indicate malware behaviour. If there are, in block 319, firewall walls can be instigated to block outgoing traffic from the network device of this type, and, in block 317, the throttle status and traffic features indicating malware behaviour if there any can be recorded.

In block 321, the throttle parameters are maintained during the current ArpW window, and in block 323 the throttling state is entered (see FIG. 4).

FIG. 4 is a flowchart of a throttling state according to an example. More particularly, FIG. 4 is a flowchart of a process followed in a throttled state in the event of an ARP request or connection according to an example. In block 401 an address resolution request or new connection is made by a network device. In block 403 it is determined if the connection is in the history list. If it is, the connection is allowed in block 405. If not, in block 407, an address resolution response is dropped or the connection is blocked. In block 409, it is determined if the request or connection relates to the same traffic that caused the throttle to engage in the first place. If yes, in block 411, the traffic is dropped, logged and the TSW is extended. If no, in block 413, the traffic is dropped, logged and the TSW is extended. In block 415. it is determined if the network device is to be rebooted. If no, in block 417, the process flow is returned to, otherwise, in block 419, the device is rebooted.

FIG. 5 is a flowchart of a non-throttled state according to an example. More particularly, FIG. 5 is a flowchart of a process followed in a non-throttled state in the event of an ARP request or connection according to an example. In block 501 an address resolution request or new connection is made by a network device. In block 503, counter C is incremented and the ArpW and TSW are checked. If the threshold is exceeded, throttling is initiated in block 505 (for which, see FIG. 3). If the threshold level is not exceeded, in block 507 a response or connection is allowed, and the request or connection is recorded in the history list. For a new connection, in block 509, the destination parameters are recorded, and in block 513 the history list is updated. For an existing connection, the appropriate history list parameters are recorded in block 511/513.

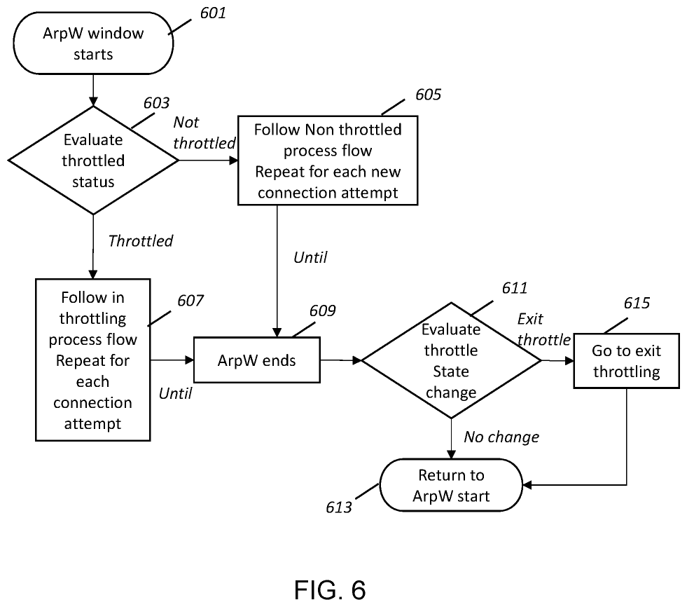

FIG. 6 is a flowchart of an ArpW process flow according to an example. In block 601, an ArpW window starts. In block 603, a throttle status is evaluated. If the network device is throttled, in block 607, the throttling process described with reference to FIG. 4 is followed. If not, in block 605, the non-throttled flow described with reference to FIG. 5 is followed. In either case, in block 609, the window ends, and the throttle state is evaluated again in block 611. If no change, in block, 613, return to block 601. Otherwise, in block 615, an exit throttling process is followed (FIG. 7) and return to block 601.

FIG. 7 is a flowchart of a process to exit throttling according to an example. In block 701, throttling exit is initiated. In block 703, the last known good history list is reinstated, and in block 705 the exit is reported to the relevant management system of the network device, and in block 707 the process returns to the window process flow described with reference to FIG. 6.

In an example, if throttling is engaged, a history list can be restored with all listed destinations initially blocked. Profiling of new traffic can be started and if malware suspected, firewall rules can be put in place to block suspect traffic. In an example, after profiling is completed other trusted traffic in the history list can be allowed. This has the effect of reacting to address resolution requests from a potentially malicious source and acting as a soft control to limit device discovery. A history list can be returned to a known good list, and all cached addresses or new addresses (not in that list) are deleted from the cache to prevent potential communications to those discovered hosts—even ongoing attacks, due to their nature of requiring multiple steps and packet flows could be stopped by this action.

According to an example, there are various different thresholds that can be used based on collected data over an observation window or number of observation windows, which can be checked against parameter C. For example:

Total number of requests exceeds a value.

Total number of non-responses exceeds a value.

Total number of unique host requests exceeds a value.

Total number of unique non-responses exceeds a value.

Other thresholds based upon other collected statistics, for example rate of change of requests or non-responses

In an example, one or multiple thresholds can be used, depending on implementation costs and effectiveness testing given the current threat environment.

Statistics and parameters may be recorded upon entering throttling, for example the resolved addresses, the requested addresses and others—so that they can be retrieved or sent for later investigation.

According to an example, the parameter TS can be used to record the current throttle state of the system, and to influence the decisions taken by the throttle upon new requests (for example extend the throttle state window, TSW, or not, or some other remedial action). Other statistics relating to throttle state can also be recorded, for example how long the system has been throttling or which thresholds have been exceeded as a measure of perceived risk. In an example, the parameter TSW can be used as a way of throttling the system for longer than the observation window—indicating how much longer in time, or number of ArpW windows (or another variable) to remain throttled for. This may vary per the perceived threat environment and other decisions made by the throttle or by policy.

In an example, in order to move from a throttled (i.e. address resolution request regulated) to a non-throttled state, throttling can be turned off as the thresholds that triggered it are no longer exceeded. In another example, malware blocking behaviours can use the throttle state window, or status of other thresholds within the system (such as time, I.T. policy etc.) to dictate when to return to normal operating behaviour.

In an example, as throttling becomes active or inactive a management system or user can be notified and provided with various statistics. Alerts can also react to the perceived risk by the throttle increasing or decreasing in frequency/severity as the system changes. Accordingly, an organisation can manage potential infections and can understand throttle behaviours and help in optimising policy rules and thresholds.

Network device addresses can change such as when equipment fails or is replaced, or as a device is moved around an organisation or reconfigured for example. Typical address resolution cache times tend to be fairly short (of the order of a number of minutes) so to this end the history list can be pruned. Parameters recorded with each entry, such as time first and last requested or others can be used to remove entries as per policy. Other methods such as those used to populate the history list (manually, enrichment source) could also be used.

Some malware can be persistent, and based upon policy as well as the perceived threat by the throttle or indeed the user action, a device may be rebooted. In an example, in this situation the ability to return the system to its previous throttled state is maintained, with only good requests maintained in the history list being allowed through, to mitigate the malware behaviour upon device restart.

Several traces were analysed of different endpoint equipment in differing network environments, to obtain example rates of address resolution requests and connection attempts to new addresses. A corporate windows 10 laptop in an office VLAN over a two hour period made:

0 ARP requests. This device was in use and so was keeping the local router address in its cache all this time; and 15 TCP SYN requests to port 445, against 3 unique destinations.

Office printers with various degrees of use over a 4 day period made:

Between 300 and 3000 ARP requests over ˜320,000 seconds to 5 unique hosts; and between 350 and 800 outgoing TCP SYN connections to 9 hosts.

When compared to the activity of a malware process:

The process probed for local machines with requests at a rate of ˜20 per second to a total of 250 hosts in the space of 60 seconds. Making 3 ARP discovery requests per host in that time, and a total of 1,700 TCP SYN requests were sent in 60 seconds.

There is therefore a large discrepancy in the behaviour of malware generated traffic and normal host traffic. Accordingly, a false positive rate will be extremely low even with quite low values for the parameters. For example:

ArpW=5 seconds

C=5 requests

TSW=4

would not trigger the throttle according to normal use cases observed, and would have triggered the throttle within a second upon observing malware traffic, and remained throttled throughout the infection and triggered a device reboot. If the malware process was persistent after the reboot the throttle would still be engaged and continue blocking traffic.

Examples in the present disclosure can be provided as methods, systems or machine-readable instructions. Such machine-readable instructions may be included on a computer readable storage medium. The storage medium can include one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of network devices or nodes may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

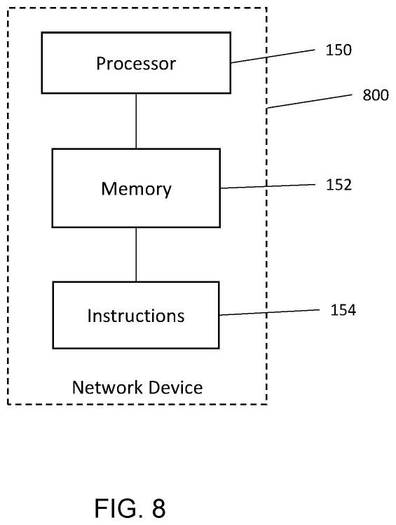

FIG. 8 shows an example of a network device 800 comprising a processor 150 associated with a memory 152. The memory 152 comprises computer readable instructions 154 which are executable by the processor 150 to, at least, monitor outgoing address resolution requests to a target device from the network device, and compare data representing a frequency of requests to the target device from the network device against a threshold profile for the network device. Instructions can be provided to regulate (throttle) the number of outgoing address resolution requests to the target device from the network device; block outgoing address resolution requests from the network device to a previously unvisited target device; and generate a set of identifiers representing network nodes, the set of indentifiers generated from one or more of: a local list of network nodes generated using successful address requests by the network device; a list of network nodes that the network device may issue an address request to; a remote list of network nodes generated using successful address requests by the network device; and a last known set of identifiers representing network nodes.

Such machine-readable instructions may also be loaded onto a computer or other programmable data processing devices, so that the computer or other programmable data processing devices perform a series of operations to produce computer-implemented processing, thus the instructions executed on the computer or other programmable devices provide a operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for address resolution request control in a network device of a network, the method comprising:
comparing address resolution requests submitted to network nodes from the network device against a predetermined threshold profile for the network device; and
regulating a flow of address resolution requests from the network device in response to the comparison.

2. A method as claimed in claim 1, further comprising:
providing a set of identifiers representing network nodes, the set of indentifiers generated from one or more of: a local list of network nodes generated using successful address requests by the network device; a list of network nodes that the network device may issue an address request to; a remote list of network nodes generated using successful address requests by the network device; and a last known set of identifiers representing network nodes.

3. A method as claimed in claim 1, wherein regulating a flow of address resolution requests further comprises:
defining an observation window; and
determining a status of an address resolution request throttle within the observation window from one of: non-throttled, in which the flow of address resolution requests from the network device is not regulated; and throttled, in which the flow of address resolution requests from the network device is regulated.

4. A method as claimed in claim 3, further comprising:
in a non-throttled status, recording connection parameters of the network device to the set of identifiers representing network nodes.

5. A method as claimed in claim 3, further comprising:
in a throttled status, checking connections requested by the network device against the set of identifiers representing network nodes; and
blocking a connection to a network node.

6. A method as claimed in claim 3, further comprising:
evaluating a throttle status at the end of the observation window. A method as claimed in claim 6, further comprising:
extending the observation window in the event that the threshold profile for the network device is exceeded.

8. A method as claimed in claim 6, further comprising:
storing a copy of the set of identifiers representing network nodes in the event that the threshold profile for the network device is not exceeded; and
restarting an observation window.

9. A method as claimed in claim 6, further comprising exiting a throttled status.

10. A non-transitory machine-readable storage medium encoded with instructions executable by a processor of a network device for throttling address resolution requests, the machine-readable storage medium comprising instructions to:
monitor outgoing address resolution requests to a target device from the network device; and
compare data representing a frequency of requests to the target device from the network device against a threshold profile for the network device.

11. A non-transitory machine-readable storage medium as claimed in claim 10, further encoded with instructions to: regulate the number of outgoing address resolution requests to the target device from the network device.

12. A non-transitory machine-readable storage medium as claimed in claim 10, further encoded with instructions to:
block outgoing address resolution requests from the network device to a previously unvisited target device.

13. A non-transitory machine-readable storage medium as claimed in claim 10, further encoded with instructions to:
generate a set of identifiers representing network nodes, the set of indentifiers generated from one or more of: a local list of network nodes generated using successful address requests by the network device; a list of network nodes that the network device may issue an address request to; a remote list of network nodes generated using successful address requests by the network device; and a last known set of identifiers representing network nodes.

14. A network device, comprising a processor to:
determine a frequency of address resolution requests from the network device to a target device; and
regulate a flow of outgoing address resolution requests to the target device in response to a comparison of the frequency against a threshold profile of the network device.

15. A network device as claimed in claim 14, the processor further to:
define an observation window within which outgoing address resolution requests are monitored.
